(19) United States
(12) Patent Application Publication
(10) Pub. No.: US 2025/0054985 A1
(43) Pub. Date: Feb. 13, 2025

(54) METHOD FOR MANUFACTURING ELECTRODE, ELECTRODE, AND BATTERY

(71) Applicant: TOYOTA JIDOSHA KABUSHIKI KAISHA, Toyota-shi (JP)

(72) Inventors: Masashi UEDA, Toyota-shi (JP); Shinji KOJIMA, Nagoya-shi (JP); Tomoko HIGO, Toyota-shi (JP)

(73) Assignee: TOYOTA JIDOSHA KABUSHIKI KAISHA, Toyota-shi (JP)

(21) Appl. No.: 18/645,580

(22) Filed: Apr. 25, 2024

(30) Foreign Application Priority Data
Aug. 9, 2023 (JP) 2023-130507

(51) Int. Cl. H01M 4/62; H01M 4/04

(52) U.S. Cl. CPC H01M 4/623; H01M 4/04; H01M 4/624

(57) ABSTRACT

A method for manufacturing an electrode includes the steps of: kneading active material particles, an electrically conductive material, and an adhesive to fix the electrically conductive material to at least part of a surface of the active material particles; mixing the active material particles having the electrically conductive material fixed to the active material particles by the adhesive with polytetrafluoroethylene to obtain a mixture; and causing the polytetrafluoroethylene in the mixture to fibrillate.

### CROSS-REFERENCE TO RELATED APPLICATION

This application claims priority to Japanese Patent Application No. 2023-130507 filed on Aug. 9, 2023, incorporated herein by reference in its entirety.

### BACKGROUND

### 1. Technical Field

The present disclosure relates to methods for manufacturing an electrode, electrodes, and batteries.

### 2. Description of Related Art

Batteries such as lithium-ion secondary batteries use electrodes in which active material particles are fixed to a surface of a current collector such as metal foil by a binder. Known methods for manufacturing an electrode include a method in which a composition prepared by mixing active material particles and a binder with a solvent is applied to a surface of a current collector (also referred to as wet method) and a method in which active material particles are fixed to a current collector by a binder without using a solvent (also referred to as dry method).

A method in which a resin having properties to fibrillate when a shear force is applied is used as a binder has been proposed as a dry method for manufacturing an electrode. For example, Japanese Unexamined Patent Application Publication No. 2022-3694 (JP 2022-3694 A) describes a method for manufacturing an electrode. In this method, an electrode is manufactured by causing fibrillation of polytetrafluoroethylene (PTFE) in a mixture containing active material particles and PTFE to prepare electrode films and integrating the electrode films with a current collector.

### SUMMARY

The electrode obtained by the method described in JP 2022-3694 A has room for improvement in electron conduction properties. It is an object of an embodiment of the present disclosure to provide a method for manufacturing an electrode with excellent electron conduction properties, an electrode with excellent electron conduction properties, and a battery including an electrode with excellent electron conduction properties.

Means for solving the above issue include the following aspects.
(1) A method for manufacturing an electrode, the method including: kneading active material particles, an electrically conductive material, and an adhesive to fix the electrically conductive material to at least part of a surface of the active material particles; mixing the active material particles having the electrically conductive material fixed to the active material particles by the adhesive with polytetrafluoroethylene to obtain a mixture; and causing the polytetrafluoroethylene in the mixture to fibrillate.
(2) In the method according to (1), a coverage of the active material particles with the electrically conductive material may be 10% or more.
(3) An electrode including a current collector and an electrode layer, wherein the electrode layer contains active material particles and fibrous polytetrafluoroethylene, the active material particles having an electrically conductive material fixed to at least part of a surface of the active material particles by an adhesive.
(4) In the electrode according to (3), a coverage of the active material particles with the electrically conductive material may be 10% or more.
(5) A battery including the electrode according to (3) or (4).

According to an embodiment of the present disclosure, a method for manufacturing an electrode having excellent electron conduction properties, the electrode having excellent electron conduction properties, and a battery including the electrode having excellent electron conduction properties are provided.

### DETAILED DESCRIPTION OF EMBODIMENTS

In the present disclosure, a numerical range indicated by using “from” means a range including the numerical values described before and after “from” as the minimum value and the maximum value, respectively. In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples. In the present disclosure, the term “step” is included in the term as long as the intended purpose of the step is achieved, even if it is not clearly distinguishable from other steps as well as independent steps. In the present disclosure, a combination of two or more preferred embodiments is a more preferred embodiment. In the present disclosure, the amount of each component means the total amount of a plurality of substances unless otherwise specified, when a plurality of substances corresponding to each component are present.

### Electrode Manufacturing Method

A method of manufacturing an electrode includes the steps of: kneading active material particles, an electrically conductive material, and an adhesive to fix the electrically conductive material to at least part of a surface of the active material particles; mixing the active material particles having the electrically conductive material fixed to the active material particles by the adhesive with PTFE to obtain a mixture; and causing the PTFE in the mixture to fibrillate.

The electrode produced by the disclosed method exhibits excellent electron conduction properties compared to electrodes formed from mixtures obtained by mixing active material particles, an electrically conductive material, and PTFE simultaneously. The reason for this is considered as follows, for example. When PTFE is caused to fibrillate with the electrically conductive material not being fixed to the active material particles by an adhesive, the electrically conductive material is incorporated into the fibrous PTFE, and the contact area between the active material particles and the electrically conductive material is not sufficiently secured. In contrast, in the disclosed method, the electrically conductive material is fixed to the surface of the active material particles by an adhesive before causing PTFE to fibrillate. Therefore, even after fibrillation of PTFE, the electrically conductive material is hardly incorporated into the fibrous PTFE, and the contact area between the active material particles and the electrically conductive material is sufficiently secured. As a result, excellent electron conduction properties are achieved. Further, in the method of the present disclosure, the electrically conductive material is fixed to the active material particles by an adhesive. Therefore, the electrically conductive material is less likely to be separated from the active material particles than in the case where the electrically conductive material is fixed to the active material particles without using an adhesive, and the contact area between the electrically conductive material and the active material particles is easily secured.

According to the method of the present disclosure, an electrode can be manufactured without using a solvent. Therefore, the method of the present disclosure is also advantageous in terms of reducing the manufacturing cost of the electrode, reducing the influence on the environment and the living body, and the like.

Hereinafter, the step of kneading active material particles, the electrically conductive material, and the adhesive to fix the electrically conductive material to at least part of the surface of the active material particles is also referred to as “step 1”, the step of mixing the active material particles having the electrically conductive material fixed to the active material particles with the PTFE to obtain a mixture is also referred to as “step 2”, and the step of causing the PTFE in the mixture to fibrillate is also referred to as “step 3”.

### Step 1

In step 1, the electrically conductive material is fixed to at least a part of the surface of the active material particles by kneading the active material particles, the electrically conductive material, and the adhesive. The type of the active material particles used in this step is not particularly limited, and may be selected from materials commonly used in the manufacture of electrodes. The active material particles may be positive electrode active material particles or negative electrode active material particles.

Examples of the positive electrode active material include a lithium transition metal composite oxide. Examples of the transition-metal include Ni, Co, Mn, Al, B, Mg, Ti, V, Cr, Fc, Cu, Zn, Ga, Sr, Zr, Nb, In, Sn, Ta, and W. Among them, a lithium transition metal composite oxide containing at least one selected from Ni, Co and Mn is preferable, and a lithium transition metal composite oxide containing Ni, Co and Mn (NCM, nickel cobalt manganese oxide) is more preferable. Specific examples of the lithium transition metal composite oxide include lithium cobaltate (LiCoO₂), lithium nickelate (LiNiO₂), lithium manganate (LiMnO₂), double oxides thereof (LiCoₓNi_{y}Mn_{z}O₂, x+y+z=1), double oxides containing an added element M′ (LiCoₐNi_{b}Mn_{c}M′_{d}O₂, a+b+c+d=1, M′: Al, Mg, Ti, Zr, or Ge), spinel type lithium manganese oxide (LiMn₂O₄), and olivine type LiMPO₄ (M: Co, Ni, Mn, Fe). Only one type or two or more types of the positive electrode active materials may be used to manufacture the electrode. The volume average particle diameter of the positive electrode active material particles is not particularly limited, and can be selected, for example, from the range of 5 μm to 30 μm.

Specific examples of the negative electrode active material include carbon materials such as graphite, soft carbon, and hard carbon, and silicon. Only one type or two or more types of the negative electrode active materials may be used to manufacture the electrode. The volume average particle diameter of the negative electrode active material particles is not particularly limited, and can be selected from, for example, a range of 5 μm to 30 μm.

The volume-average particle size of the particles is a D50 when the 10 cumulative particle size from the smaller diameter side is 50% in the volume-based particle size distribution measured by the laser diffractometry and scattering method.

The type of the electrically conductive material used in this step is not particularly limited, and may be selected from materials commonly used to manufacture electrodes. Specific examples of the electrically conductive material include carbon black (acetylene black, thermal black, furnace black, and the like), carbon nanotubes, and carbon materials such as graphite. Only one type or two or more types of the electrically conductive materials may be used to manufacture the electrode.

The type of the adhesive used in this step is not particularly limited, and may be selected from materials commonly used in the manufacture of batteries. Specific examples of the adhesive include polyvinylidene fluoride, polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, and polymethacrylate. Only one type or two or more types of the adhesive may be used in this step. From the viewpoint of adhesive strength, compatibility with PTFE, electrolyte resistance, and the like, polyvinylidene fluoride (PVdF) is preferable as the adhesive.

From the viewpoint of obtaining a sufficient effect of improving the electron conduction properties, the coverage of the surface of the active material particles with the electrically conductive material is preferably 10% or more, more preferably 20% or more, and still more preferably 30% or more. The coverage of the surface of the active material particles with the electrically conductive material may be 80% or less, 70% or less, 60% or less, or 50% or less.

The coverage of the surface of the active material particles with the electrically conductive material is measured by an image analysis method. Image analysis methods include methods in which C-mapping is performed by energy-dispersive X-ray spectroscopy (EDX). Specifically, the active material particles to which the electrically conductive material is fixed by an adhesive are observed by a scanning electron microscope (SEM), and C-mapping is performed by an EDX. The region X corresponding to the active material particles and the region Y of the region X in which the electrically conductive material (C) is present are binarized, and the coverage is calculated by the following formula.

$$Coverage ( \% ) = ( area of Y / area of X ) \times 100$$

In this step, the method of kneading the active material particles, the electrically conductive material, and the adhesive is not particularly limited as long as the electrically conductive material can be fixed to the surface of the active material particles, and can be carried out using known means. The amount of the electrically conductive material with respect to 100 parts by mass of the active material particles is, for example, 0. It may be selected from the range of 1 part by mass to 10 parts by mass, or 1 part by mass to 5 parts by mass. The amount of the adhesive with respect to 100 parts by mass of the active material particles is, for example, 0. It may be selected from the range of 1 part by mass to 10 parts by mass, or 1 part by mass to 5 parts by mass.

### Step 2

In step 2, the active material particles to which the electrically conductive material is fixed with an adhesive and PTFE are mixed to obtain a mixture. The method of mixing is not particularly limited, and can be carried out using known means. The amounts of PTFE relative to 100 parts by weight of active material particles in the mixture are, for example, 0. It may be selected from the range of 1 part by mass to 10 parts by mass, or 1 part by mass to 5 parts by mass.

PTFE mixed with the active material in step 2 may be particulate. The mixture obtained in step 2 may be solvent-free. In the step 2, at least a part of PTFE may be caused to fibrillate, and a granulated material in which the active material particles are bound by the fibrillated PTFE may be produced.

The mixture of the active material particles and PTFE to which the electrically conductive material is fixed by an adhesive may include a binder other than PTFE. The binder other than PTFE may be selected from the adhesives described above, for example. When the mixture contains a binder other than PTFE, the content thereof may be 20 parts by mass or less, 10 parts by mass or less, or 5% by mass or less based on 100 parts by mass of PTFE.

### Step 3

In step 3, PTFE in the mixture obtained in step 2 is caused to fibrillate. The method for causing PTFE to fibrillate is not particularly limited, and can be carried out using a known method. From the viewpoint of workability when integrating the mixture after fibrillating PEFE with the current collector, in step 3, it is preferable to cause PTFE to fibrillate and form the mixture into a sheet. Examples of methods for causing PTFE to fibrillate and forming the mixture into a sheet include a rolling process using a roll press machine.

The thickness of the molded body obtained by forming the mixture into a sheet is not particularly limited, and can be adjusted according to the desired thickness of the electrode layer. For example, the thickness of the molded body can be selected from the range of 10 μm to 200 μm.

After causing PTFE to fibrillate in step 3, the mixture, preferably a sheet-like shaped body, is integrated with the current collector to form an electrode. The method of integrating the mixture after fibrillation of PTFE with the current collector is not particularly limited, and can be carried out using a known method. For example, the mixture and the current collector may be pressure-bonded using a roll press, a flat plate press, or the like. The material of the current collector is not particularly limited, and may be selected from known materials such as aluminum, copper, nickel, titanium, and stainless steel.

### Electrode

The electrode includes a current collector and an electrode layer, and the electrode layer includes active material particles in which an electrically conductive material is fixed to at least a part of the surface with an adhesive, and fibrous PTFE (PTFE fibers).

The electrode of the present disclosure exhibits excellent electron conduction properties compared to an electrode in which an electrically conductive material is not fixed to the surface of active material particles with an adhesive.

The details and preferred aspects of each material included in the electrodes and electrodes of the present disclosure are the same as the details and preferred aspects of the electrodes and each material used in the above-described method for manufacturing an electrode.

The electrode may further include a member other than the electrode layers including the current collector, the active material particles, and PTFE fibers. For example, the disclosed electrodes may further include electrode layers that do not include PTFE fibers.

### Battery

The battery of the present disclosure includes the electrode of the present disclosure described above. The battery of the present disclosure includes the electrode of the present disclosure as at least one of a positive electrode and a negative electrode, and in some embodiments, includes the electrode of the present disclosure as a positive electrode.

The type of battery of this disclosure is not specifically restricted and can be selected from: lithium ion secondary battery (including liquid system battery and total solid cell), lead battery, nickel/hydrogen battery, nickel/cadmium battery, nickel/iron battery, nickel/zinc battery, silver/zinc oxide battery, cobalt titanium lithium secondary battery, sodium ion secondary battery, etc.

Hereinafter, the present disclosure will be described in more detail with reference to Examples, but the disclosure of the present disclosure is not limited to these Examples.

### Examples

### Preparation of Positive Electrode

The following materials were put into a MP mixer (Nippon Coke Industries Co., Ltd.), and a compounding treatment was performed in which an electrically conductive material was fixed to the active material particles with an adhesive in a 10000 rpm of 10 minutes.
Positive electrode active material particles: NCM (volume-average particle diameter: 10 μm, 96.6 parts by mass)
Electrically conductive material: acetylene black (1.5 parts by mass)
Adhesive: PVdF (0.5 parts by mass)

PTFE (1.4 parts by mass) was further added to the MP mixer after the complexation process and mixed at 300 rpm for 180 seconds. Then, the active material particles were further mixed at 5000 rpm for 500 seconds so as to form a granulated material bound in the fibrillated PTFE.

The mixture containing the granulated material is rolled in a roll press (linear rolling: 0.4 t/cm) to cause PTFE to fibrillate and form the mixture into a sheet (thickness: 120 μm). A sheet-like molded article and an aluminum foil (thickness: 12 μm) as a current collector were bonded together by a roll press (linear pressure: 4 t/cm, 160° C.).

### Comparative Example

### Preparation of Positive Electrode

The following ingredients were introduced into a MP mixer (Nippon Coke Industries Co., Ltd.) and mixed at a 300 rpm of 180 seconds. Then, the active material particles were further mixed at 5000 rpm for 500 seconds so as to form a granulated material bound in the fibrillated PTFE. The amount of binder was set such that the total volume was equal to the total volume of binder used in Example 1.
Positive electrode active material particles: NCM (volume-average particle diameter: 10 μm, 96.5 parts by mass)
Electrically conductive material: acetylene black (1.5 parts by mass)
Binder: PTFE (2.0 parts by mass)

The mixture containing the granulated material is rolled in a roll press (linear rolling: 0.4 t/cm) to cause PTFE to fibrillate and form the mixture into a sheet (thickness: 10 μm). A sheet-like molded article and an aluminum foil (thickness: 12 μm) as a current collector were bonded together by a roll press (linear pressure: 4 t/cm, 160° C.).

### Evaluation of Coverage

The cross-section obtained by cutting the positive electrode prepared in Examples and Comparative Examples was observed by SEM, and C-mapping was performed by an EDX attached to SEM to calculate the coverage of the active material particles with the electrically conductive material. The results are shown in Table 1.

### Evaluation of Electron Conduction Properties

As an index of the electron conduction properties of the positive electrode prepared in the Examples and Comparative Examples, the resistance (electrode layer resistance) inside the electrode layer and the resistance (interface resistance) at the interface between the electrode layer and the current collector were measured using an electrode resistance measuring system RM2610 (manufactured by Nikki Electric Co., Ltd.). The results are shown in Table 1.

A small cell for measuring IV resistivity was manufactured using the positive electrode manufactured in Examples and Comparative Examples and the negative electrode manufactured by the methods described below. Using this small cell, IV resistivity was calculated in the manner described below. The results are shown in Table 1. Measurement method: discharge at a current I of 0.3 C for 10 seconds and measure a voltage drop ΔV for the 10 seconds. IV resistance is calculated from the relation between the current I and ΔV.

### Preparation of Negative Electrode

A negative electrode was prepared by coating a copper foil (thickness: 8 μm) as a current collector with paste containing graphite (volume average particle diameter: 20 μm, 98 parts by mass) as a negative electrode active material, carboxymethyl cellulose (0.4 parts by mass) as a binder, and SBR (1.6 parts by mass).

TABLE 1

| | | Electrode | | |
|---|---|---|---|---|
| | | Layer | Interfacial | |
| | Coverage | Resistance | resistance | IV resistor |
| | [%] | [Ω · cm] | [Ω · cm²] | [Ω] |
| Examples | 37.4 | 29.7 | 1.0 | 0.9 |
| Comparative | 0.8 | 55.5 | 1.7 | 1.2 |
| Example | | | | |

As shown in Table 1, the positive electrode of the example prepared from the active material particles and PTFE in which the electrically conductive material is fixed to the surface with an adhesive has a higher coverage of the active material with the electrically conductive material than the positive electrode of the comparative example prepared from the active material particles and PTFE in which the electrically conductive material is not fixed to the surface with an adhesive. Furthermore, in the positive electrode of the example prepared from the active material particles and PTFE in which the electrically conductive material is fixed to the surface with the adhesive, the electrode layer resistance, the interfacial resistance, and IV resistance are both lower than those of the positive electrode of the comparative example prepared from the active material particles and PTFE in which the electrically conductive material is not fixed to the surface with the adhesive. The above results suggest that the fact that the electrically conductive material is fixed to the surface of the active material particles by an adhesive enhances the coverage of the active material particles with the electrically conductive material, and further contributes to the improvement in electron conduction properties.

What is claimed is:

1. A method for manufacturing an electrode, the method comprising the steps of:
kneading active material particles, an electrically conductive material, and an adhesive to fix the electrically conductive material to at least part of a surface of the active material particles;
mixing the active material particles having the electrically conductive material fixed to the active material particles by the adhesive with polytetrafluoroethylene to obtain a mixture; and
causing the polytetrafluoroethylene in the mixture to fibrillate.

2. The method according to claim 1, wherein a coverage of the active material particles with the electrically conductive material is 10% or more.

3. An electrode comprising a current collector and an electrode layer, wherein the electrode layer contains active material particles and fibrous polytetrafluoroethylene, the active material particles having an electrically conductive material fixed to at least part of a surface of the active material particles by an adhesive.

4. The electrode according to claim 3, wherein a coverage of the active material particles with the electrically conductive material is 10% or more.

5. A battery comprising the electrode according to claim 3.
